(19) United States
(12) Patent Application Publication
(10) Pub. No.: US 2013/0039530 A1
(43) Pub. Date: Feb. 14, 2013

(54) System and Method for Replacing a Key

(71) Applicant: Caesar Gerard Manigault, (US)

(72) Inventor: Caesar Gerard Manigault, (US)

(21) Appl. No.: 13/204,813

(22) Filed: Aug. 8, 2011

(51) Int. Cl. G06K 9/00

(52) U.S. Cl. 382/100

(57) ABSTRACT

A system and method for replacing a key is described herein. Specifically, a system for replacing a key can comprise a network, a server that receives a still photograph from a mobile device, wherein said still photograph is related to a key. In another embodiment, the system for replacing a key can also comprise a memory that stores an application, one or more locksmith record and one or more user profile comprising key data. The system for replacing a key can further comprise a processor that, at the direction of said application, determines edge location from said still photograph using a predetermined threshold, determine a key code from said edge location, and stores said key code into said memory.

### BACKGROUND

This disclosure relates to a system and method for replacing a key.

Today, locksmiths are called upon to unlock doors because people break, lose or misplace their keys. Replacing a key can be very tedious for both the key owner and a locksmith. First of all, a locksmith needs to determine and ensure that the blind code to duplicate the key is accurate. As such, he is required to be onsite to open the door locker and seek for the proper codes by looking at the tumblers. Once the blind codes are obtained, the locksmith will have to travel back to his workshop, mobile or stationary, and translate the key into bitting code. Once the translation is completed, the locksmith can start cutting the key blank using his code machine. After duplicating the key, the locksmith will have to test the duplicated key either onsite or using the door locker he brought during his first visit. Such onsite visits and tumbler review can take a long time.

Therefore, it would be advantageous to have an improved system and method for replacing a key.

### SUMMARY

A system and method for replacing a key is described herein.

In one embodiment, a system for replacing a key can comprise a network, a server that receives a still photograph from a mobile device, wherein said still photograph is related to a key. In another embodiment, the system for replacing a key can also comprise a memory that stores an application, one or more locksmith record and one or more user profile comprising key data. The system for replacing a key can further comprise a processor that, at the direction of said application, determines edge location from said still photograph using a predetermined threshold, determine a key code from said edge location, and stores said key code into said memory.

Additionally, a method for replacing a key is disclosed. The method can comprise receiving a still photograph from a mobile device, wherein said still photograph is related to a key, determining edge location from said still photograph using a predetermined threshold, calculating said edge location into key codes using a method, and storing said key codes into said memory.

Finally, in one embodiment, the system for replacing a key can comprise a computer usable medium having a computer readable program code embodied therein, wherein the computer readable program code is adapted to be executed to implement the above mentioned method.

### BRIEF DESCRIPTION OF THE DRAWINGS

FIG. 1 illustrates a communication network system comprising a plurality of communication devices.

FIGS. 2A and 2B illustrate mobile device. FIG. 2A illustrates output devices on mobile device.

FIG. 2B illustrates internal hardware within mobile device.

FIG. 3 illustrates memory.

FIG. 4 illustrates internal hardware of server.

FIG. 5 illustrates server memory.

FIG. 6 illustrates a user profile including one or more key records, a Vehicle Identification Number (“VIN”) record, and a user identification number.

FIG. 7 illustrates a locksmith profile containing details of a locksmith, services offered by said locksmith, and a license number.

FIG. 8 illustrates a plurality of system buttons using mobile application stored in mobile device.

FIG. 9 illustrates a still photograph of a car key 900 captured by the optical device from mobile device.

FIG. 10 illustrates a close up preview of blade.

FIG. 11 illustrates a sample of blade comprising of a set of cut characteristics that can be combined into a key code.

FIG. 12 illustrates various methods of determining edges in key.

FIG. 12A illustrates edges of key using the Sobel method.

FIG. 12B illustrates edges of key using geometric method of finding the local minima and maxima.

FIG. 12C illustrates a plotted graph.

FIG. 13 illustrates a portion of a still photograph in a waveform using Laplacian as its derivative.

FIG. 14A illustrates a key blank.

FIG. 14B illustrates key blank interposing to key.

### DETAILED DESCRIPTION

Described herein is a system and method for replacing a key. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

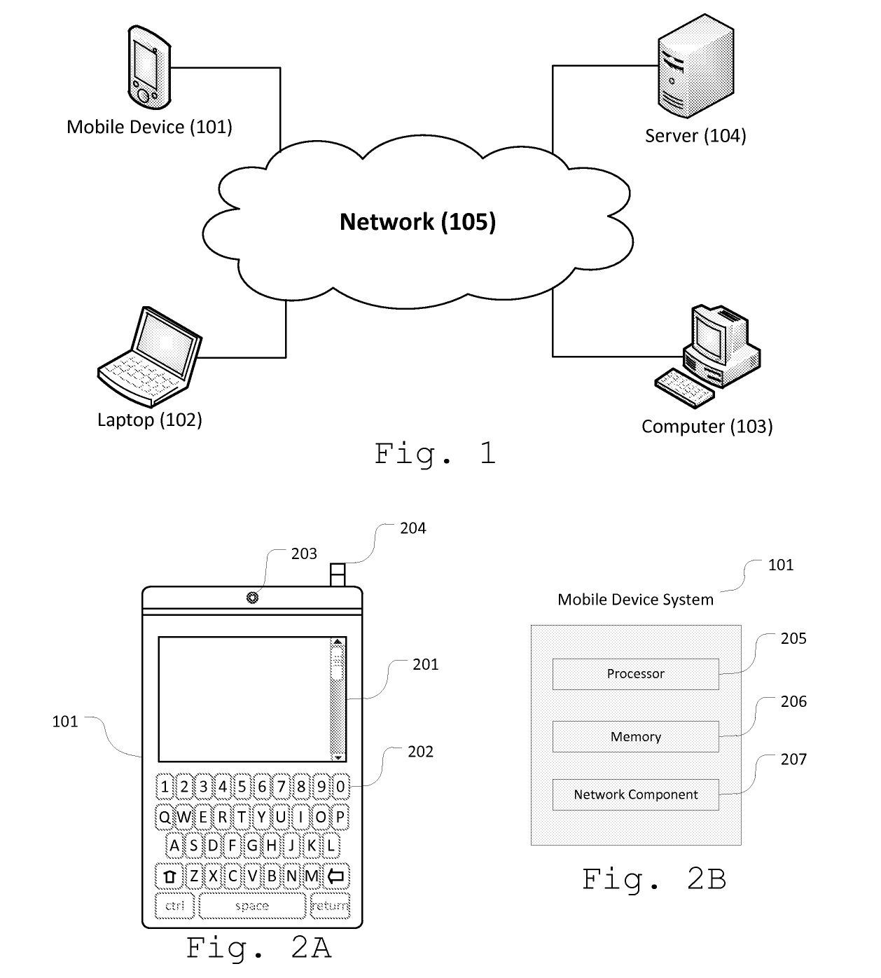

FIG. 1 illustrates a communication network system 100 comprising a plurality of communication devices. Communication devices can include a mobile device 101, a laptop 102, a computer 103, and a server 104. Mobile device 101 can connect to a network 105, which can connect to server 104. Network 105 can be a local area network (LAN), a wide area network (WAN), a piconet, or a combination of LANs, WANs, or piconets. One illustrative LAN is a network within a single business. One illustrative WAN is the Internet. Network 105 can be hard-wired, wireless, or a combination of both. Server 104 represents at least one, but can be many servers, each connected to network 105.

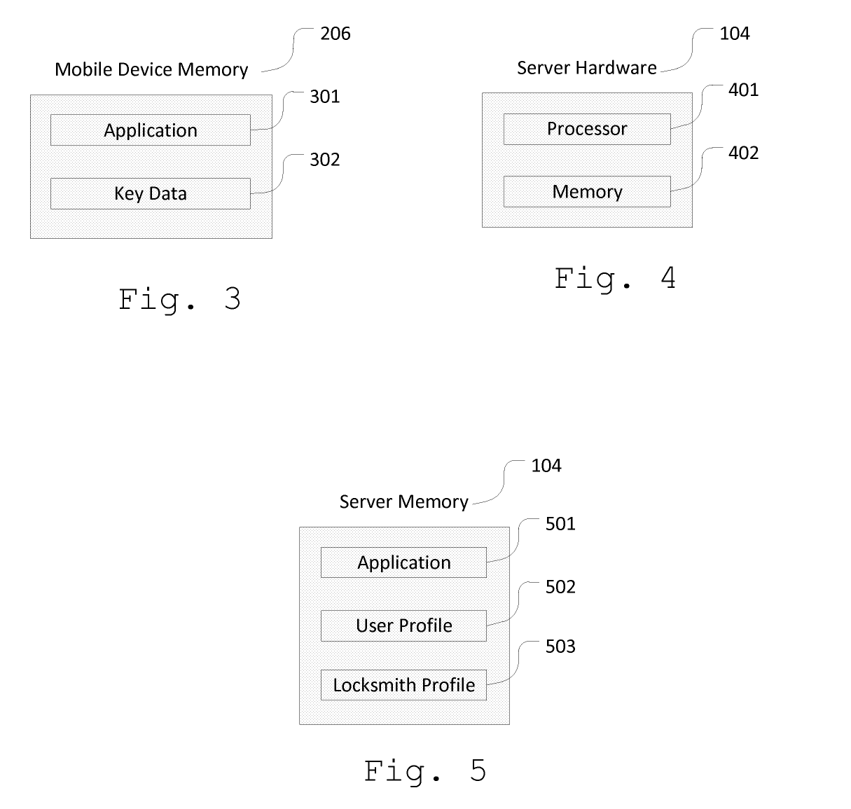

FIGS. 2A and 2B illustrate mobile device 101. FIG. 2A illustrates output devices on mobile device 101. Mobile device 101 can include, but is not limited to, a screen 201, a keypad 202, an optical device 203, and a receiver-transmitter device 204. Other input devices can include track balls, joy sticks, or scroll wheels. Screen 201 can be a mere display output, or may also be a touch screen, allowing for capture of input data. Keypad 202 can comprise of a plurality of physical buttons on mobile device 101, however in an embodiment where screen 201 is a touch screen, keypad 202 can be represented virtually on screen 201. Optical device 203 can be a small camera allowing the capture and the storing of still photographs. Receiver-transmitter device 204 can be an antenna allowing receiving and transmitting data over communication network system 100. In another embodiment, receiver-transmitter device 204 can include a Global Positioning System (“GPS”).

FIG. 2B illustrates internal hardware within mobile device 101. Captured data from screen 201, keypad 202, optical device 203, and/or receiver-transmitter 204 is sent to a processor 205. For example, captured data can include data which mobile device 101 can capture such as still photographs, string of characters, and/or location data. Processor 205 can perform processes on the data according an application stored in a memory 206, as discussed further below. Processes can include but is not limited to, storing captured data to memory 206, detecting and defining edges from still photographs, and/or determining the location of mobile device 101. Mobile device 101 can transmit captured data over communication network system 100 using network component 207. Network component 207 can include a network transport processor for packetizing data, communication ports for wired communication, or an antenna for wireless communication. Additionally, a user can also receive data from server 104 across network 105 through network component 207.

As an example of such embodiment, a user can view pictures of some generic key types, and select from the list the appropriate key type. Once selection is done, the user can capture a plurality of photographs consisting of different angles and different positions of such key. Examples of key types are, but are not limited to, a double-sided key, a four-sided key, a paracentric key, a grooved key, and/or a valet key. Once captured and stored within memory 206, the user can transmit the still photographs to server 104 over network 105 using network component 207.

FIG. 3 illustrates memory 206. Memory 206 can comprise of a mobile application 301. Mobile application 301 can execute within memory 206 and, at the instruction of a user, can gather key data 302 from optical device 203. Key data 302 can include, but is not limited to, one or more still photographs of a key, a username, account information, a bitting code, and/or a Vehicle Identification Number (“VIN”). Gathering data can include analyzing still photographs. In another embodiment, such analysis can be done at the server side. In one embodiment, mobile application 301 is capable of transmitting key data 302 from memory 206 across communication network 100 to other server 104 using messages. Messages can include, but is not limited to, an Electronic Mail (“EMAIL) and/or a Short Message Service Text (“SMS”).

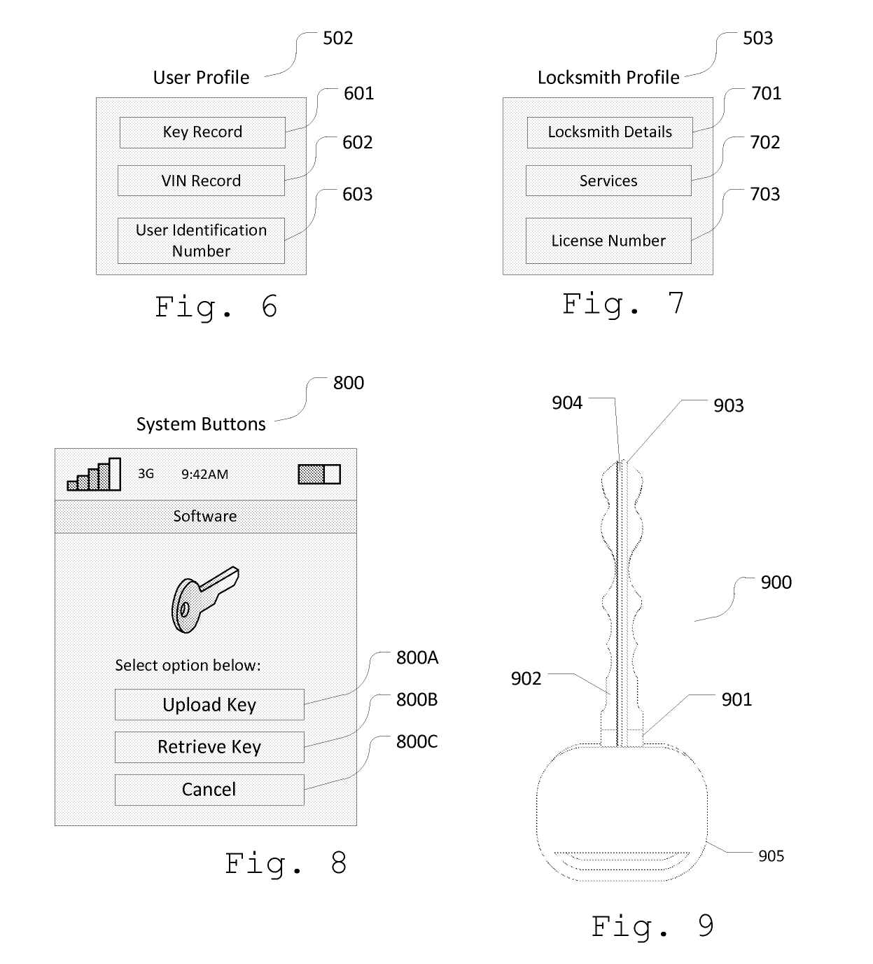

FIG. 4 illustrates internal hardware of server 104. Server 104 can comprise a server processor 401, and a server memory 402. Server processor 401 can analyze a still photograph of a key captured by mobile device 101 and translate it into a bitting code and stores such bitting code within server memory 402. By means of translating a still photograph of a key into a bitting code, server processor 401 can apply an edge detection filter over a still photograph and compute the edge strength by finding the gradient magnitude using a set of threshold. Once the gradient magnitude is identified, server processor 401 can search the gradient direction until an edge is detected, as discussed further below.

FIG. 5 illustrates server memory 402. Server memory can comprise a server application 501, one or more user profiles 502, and one or more locksmith profiles 503. Server application 501 can process user profiles 502 and locksmith profiles 503 stored within server memory 402. Processes can include creating, storing, and modifying user profiles 502 and locksmith profiles 503.

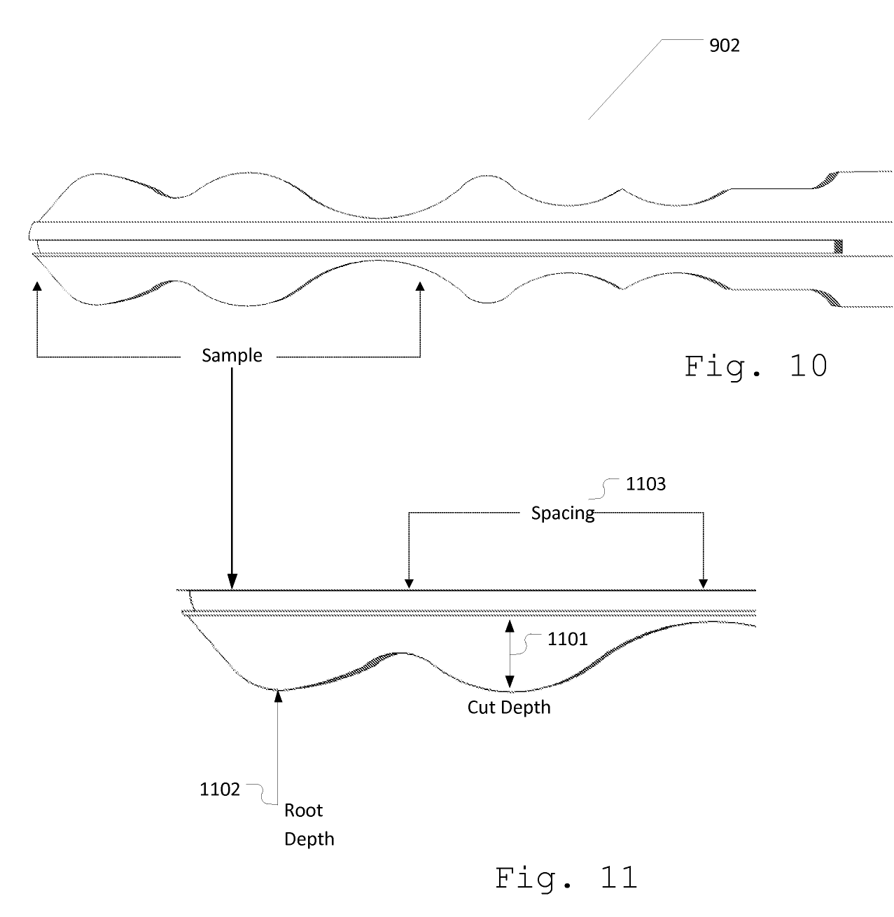

FIG. 6 illustrates a user profile 502 including one or more key records 601, a Vehicle Identification Number (“VIN”) record 602, and a user identification number 603. Key record 601 can consists of a still photograph of a key using mobile device 101. In another embodiment, key record 601 can comprise of a key bitting code translated from a still photograph of a key stored in server memory 402. VIN record 602 can consist of an identification number related to a vehicle of a user. User identification number 603 can be a string, or combination of strings, of letters numbers and/or symbols. In one embodiment, user identification number 603 can be generated by server application 501. In another embodiment, user identification number 603 can also be manually keyed by a user. For example, user identification number 603 can include, but is not limited to, an Electronic Mail (“EMAIL”) address, a telephone number, a user ID, and/or can be a combination of email, telephone number and/or user ID.

FIG. 7 illustrates a locksmith profile 503 containing locksmith details 701, services 702 offered by said locksmith, and a license number 703. Locksmith details 701 can comprise information such as a locksmith name, a company name, a location of a locksmith, and a serviceable location. Services 702 can be a list of services offered by one or more locksmiths. Services 702 can include but is not limited to, fixing and installing locks, making a new key for locks, and/or changing/upgrading locks. License number 703 can be the locksmith security license that a locksmith must complete prior to perform duties since a locksmith perform a variety of jobs that require the strictest confidentiality and professionalism. License number 703 can be a set of string with a combination of letters, numbers and/or symbols and is manually keyed into server 104, for example, “AL9532TX”.

FIG. 8 illustrates a plurality of system buttons 800 using mobile application 301 stored in mobile device 101. System buttons 800 can include an upload key 800A, a retrieval key 800B, and a cancel key 800C. Upload key 800A can transmit key data 302 to server 104 across communication network system 100. Retrieval key 800B can retrieve locksmith detail 701 from server 104 across communication network system 100. For example, a user can press on the retrieval key 800B in order to reproduce his lost key. Once pressed, mobile application 301 can start communicating to server 104 and request key data 302 from server 104. Server 104 can then transmit relevant key data 302 such as a service location, and the bitting code to mobile device 101. Cancel Key 800C can close mobile application 301 and can revert the mobile screen to its previous state.

FIG. 9 illustrates a still photograph of a car key 900 captured by the optical device 203 from mobile device 101. Key 900 can comprise a shoulder 901, a blade 902, a tip 903, a milling groove 904, and a bow 905. FIG. 10 illustrates a close up preview of blade 902.

FIG. 11 illustrates a sample of blade 902 comprising of a set of cut characteristics that can be combined into a key code. A key code can be a series of alphanumeric characters used by a locksmith to create a key. To determine a key code, a locksmith can decipher the height of a key pin for a specific lock. Each key pin can be an integer number from 0 to 9 with 0 is the shortest pin and shallowest cut on the key, and 9 is the longest pin and deepest cut on the key, referred as the cut depth 1101. Cut depth 1101 can be expressed in several ways. First, cut depth 1101 can be expressed by a pin number of a lock. Second, cut depth 1101 can also be explained by the depth of cut taken away from a key blank and can be equal to the length of the pins of a lock. And third cut depth 1101 can further be explained by the root depth 1102 that is measured from the bottom of key blank to top of the cut.

Spacing 1103 can be measured using two different means. One means of measuring is from the distance from the center of one cut to the center of an adjacent cut, referred as cut to cut. Another means of measuring is from the edge of the shoulder of the key to the center of the first cut.

To cut car key 900, a locksmith requires a bitting code, which can be determined using the characteristics of car key 900. Each key has its own set of cut characteristics and is cut in such a way as to lift each individual pin to its correct height to unlock a lock. In this example, a key code can be read as 2516. Therefore, 2 can represent the pin number, 5 can represent cut depth 1101, 1 can represent root depth 1102, and 6 can represent spacing 1003. A locksmith can use the said code to start cutting car key 900.

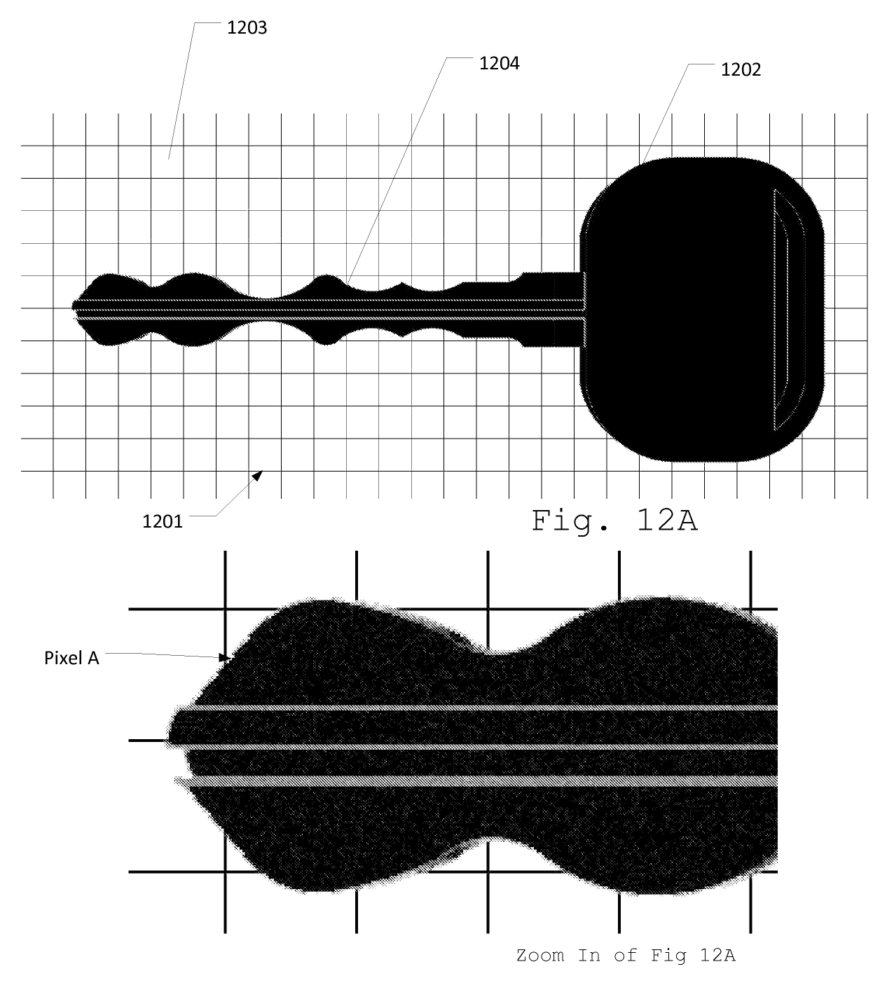

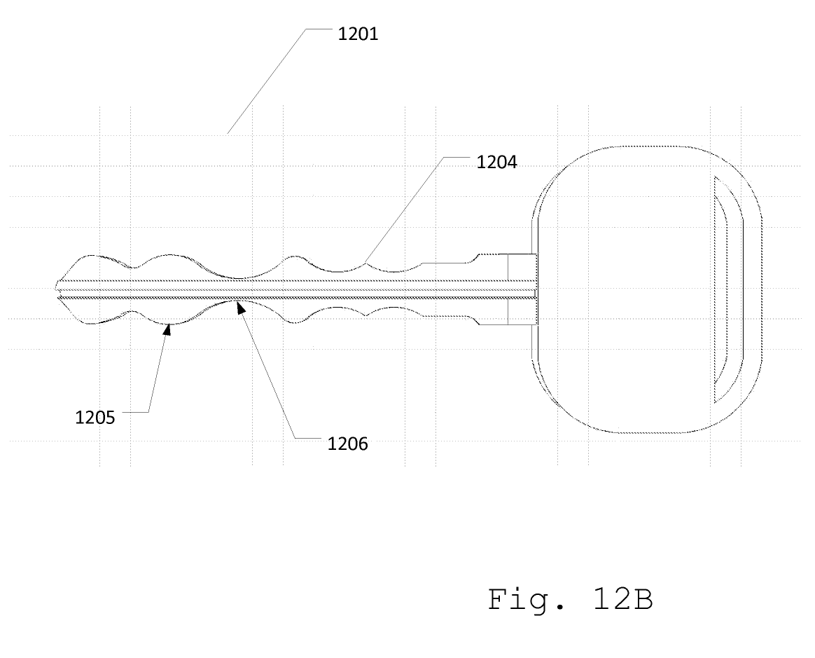

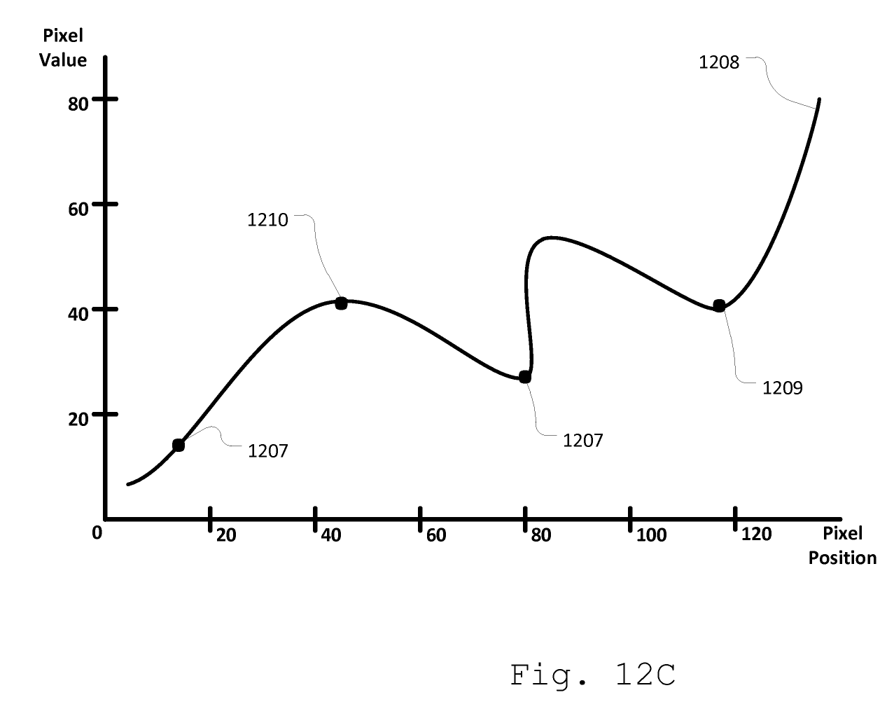

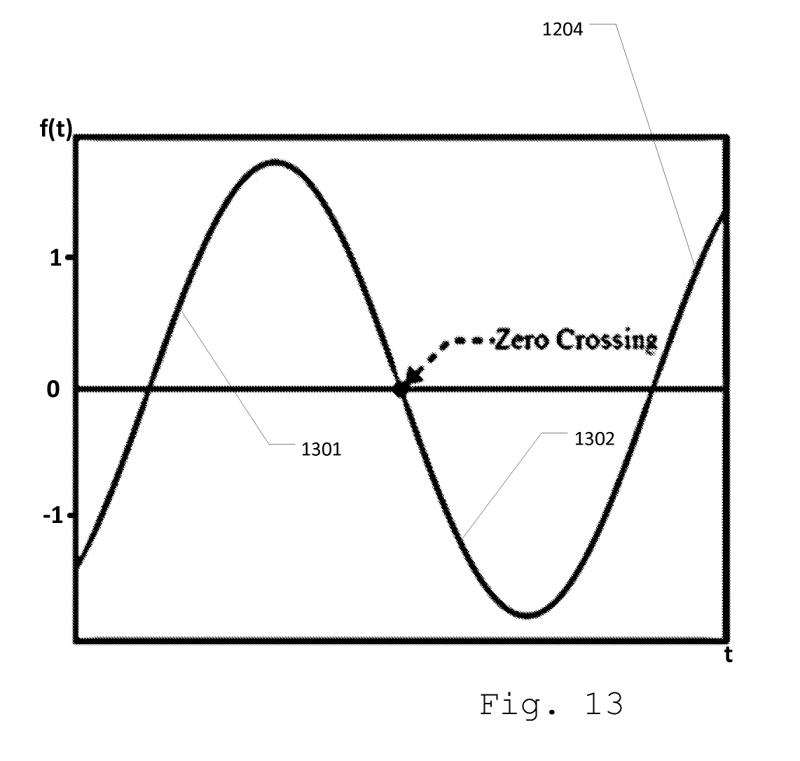

FIG. 12 illustrates various methods of determining edges in key 900. FIG. 12A illustrates edges of key 900 using the Sobel method. Edges characterize boundaries and are areas with strong intensity contrasts with a jump of intensity from one pixel to another. Generally, edges will have a higher luminous pixel intensity values than those surrounding it. In relation to key 900, edge detection is required in order to find the exactitude of bitting codes. Thus, a pixel grid 1201 can be applied on key 900 forming a plurality of pixel locations 1203, and a gray scale mask 1202 can be applied to key 900 to saturate the image such that a pixel comparison can be performed. For each pixel location, the luminous intensity in each grid is computed against a set of thresholds. If such value is higher than the threshold, the pixel location can be considered as an edge location. For example, if the luminous value of pixel A is 90, and the luminous intensity threshold is set to 50, then pixel A is considered as potential edge location. Therefore, at each interval, the other grids are also computed and each pixel location that has higher pixel intensity can be associated to the edge location until a boundary is formed. Such boundary can be identified as the edge direction. Using the edge direction of key 900, the other potential edge location can be identified with ease. And by continuing applying the intensity threshold all over the grid of key 900, an edge 1204 can be substantially produced along each characteristic of key 900, as shown in FIG. 12A.

FIG. 12B illustrates edges of key 900 using geometric method of finding the local minima and maxima. FIG. 12C illustrates a plotted graph. Pixels 1205 that lie on a line 1206 are often detected by detecting the local minima and the local maxima of the first derivative. Therefore to determine if such edge exists, each pixel is calculated against intensity of magnitude through vertical and horizontal scanning using pixel grid 1201 for each dot per inch in pixel grid 1201. Once a pixel location is considered as a potential edge location, a coordinate 1207 of the pixel location is plotted in a graph. The calculation can be repeated for each pixel location until a full scanning over key 900 is completed. While each coordinate is plotted, a full curve 1208 or a full line is developed. From such curve or line, local minima 1209 and local maxima 1210 can be calculated to find each pixel that lies on edge 1204 of key 900, as shown in FIG. 12C.

FIG. 13 illustrates a portion of a still photograph in a waveform using Laplacian as its derivative. The Laplacian method searches for zero crossing in the signal stream of key 900 image to find its boundaries. Any signal stream that passes through zero can be considered as a potential edge point. Therefore, in such embodiment, edge 1204 has a one dimensional shape of a ramp 1301 and a slope 1302. Calculating the derivative of each ramp 1301 and slope 1302 from key 900 image can highlight the location of zeros. Each zero found in the signal stream can represent the boundaries of each characteristic of key 900. For example, milling groove 904 can be represented by FIG. 13.

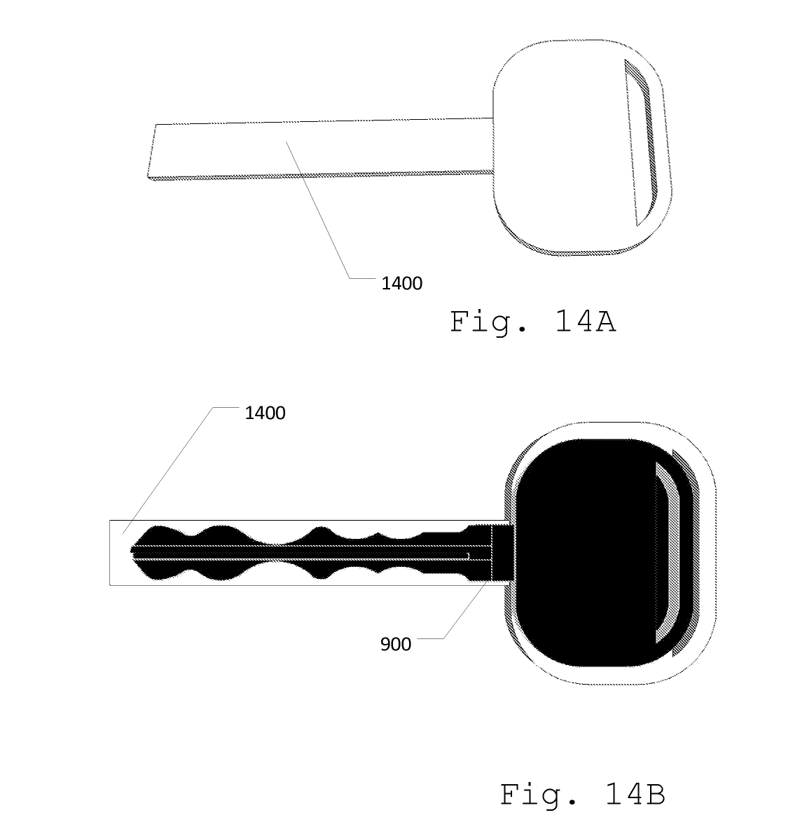

FIG. 14A illustrates a key blank 1400. FIG. 14B illustrates key blank 1400 interposing to key 900. Once edge 1204 has been fully determined, server application 501 can compare key 900 with a key blank 1400. By interposing key 900 to key blank 1400, server application 501 can determine each difference between key 900 and key blank 1400 and measure them. Once all differences have been determined, server application 501 can translate the differences into cut depth 1101 and root depth 1102 for cutting key blank 1400 identically as key 900. Combining the still photographs of key 900 with the translated codes obtained from the edge detection software, a locksmith can determine which type of key blank can be required for the duplication of key 900.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A system for replacing a key comprising
a network;
a server that receives a still photograph from a mobile device, wherein said still photograph is related to a key;
a memory that stores
an application;
one or more locksmith records;
one or more user profiles comprising key data; and
a processor that, at the direction of said application,
determines edge location from said still photograph using a predetermined threshold;
determine a key code from said edge location; and
stores said key code into said memory.

2. The server of claim 1 wherein said key data comprises a VIN number.

3. The server of claim 1 wherein said key data comprises key information that is associated with a user which is stored in said user profile within said memory.

4. The server of claim 1 wherein said locksmith record comprises a serviceable location.

5. The server of claim 1 wherein said locksmith record comprises services offered in association with said serviceable location.

6. A method for replacing a key comprising
receiving a still photograph from a mobile device, wherein said still photograph is related to a key;
determining edge location from said still photograph using a predetermined threshold;
calculating said edge location into key codes using a method; and
storing said key codes into said memory.

7. The method of claim 6 wherein said calculation is based on first derivative of said still photograph.

8. The method of claim 6 wherein said calculation is based on second derivative of said still photograph.

9. The method of claim 6 wherein said method is the Sobel method.

10. The method of claim 9 wherein said Sobel method comprise applying a pixel grid to said still photograph creating a plurality of pixel locations, and further apply a gray scale mask to said still photograph to compute luminosity in each said pixel location.

11. The method of claim 6 wherein said method is the Laplacian method.

12. The method of claim 11 wherein said Laplacian method comprise searching for zero values in a signal stream of still photograph.

13. The method of claim 12 wherein said signal stream crosses zero is considered as a zero crossing.

14. The method of claim 13 wherein said zero crossings are considered as a potential edge location.

15. The method of claim 6 wherein said method comprises comparing pixel intensity from said pixel location to other said pixel location.

16. The method of claim 15 wherein said pixel intensity is calculated using dots per inch.

17. The method of claim 15 wherein said pixel intensity depends on said threshold, wherein
said threshold depends on luminosity of said still photograph.

18. A computer usable medium having a computer readable program code embodied therein, wherein the computer readable program code is adapted to be executed to implement the method of claim 6.
